(19) United States
(12) Patent Application Publication
(10) Pub. No.: US 2010/0106593 A1
(43) Pub. Date: Apr. 29, 2010

(54) INTERNET EXCHANGE BROKER METHOD AND SYSTEM

(76) Inventors: Per Willars, Vaxholm (SE); Pankaj Asundi, Plano, TX (US); Ulf Andersson, Lewisville, TX (US); Anders Lundvall, Taby (SE); Mikael Timsater, Stockolm (SE)

Correspondence Address: ERICSSON INC., 6300 LEGACY DRIVE, M/S EVR 1-C-11, PLANO, TX, 75024, US

(21) Appl. No.: 12/532,793

(22) PCT Filed: Mar. 20, 2008
(86) PCT No.: PCT/IB2008/000675

§ 371 Date: Sep. 23, 2009

Related U.S. Application Data
(60) Provisional application No. 60/896,812, filed on Mar. 23, 2007.

(51) Int. Cl. G06Q 30/00; G06Q 10/00; G06F 15/16

(52) U.S. Cl. 705/14.41; 705/14.69; 705/14.4; 709/206; 709/217

(57) ABSTRACT

An Internet Exchange and a method thereof, wherein the Internet Exchange is arranged between at least one mobile network operator and at least one Internet content provider. An operator domain may include a component containing network presence information; a component containing global location information of a mobile station; and a component containing awareness and context information for the mobile station. Gateways may retrieve this information from the operator domain components and may deliver messages and advertisement consumption information between the mobile network operator and the Internet content provider. A user data management component may manage interactions between the mobile network operator, the operator domain components, the mobile station, and the Internet content provider; and a content aggregation and management component may manage, store, format, and deliver media information supplied by the Internet content provider to the mobile network operator.

### CROSS-REFERENCE TO RELATED APPLICATIONS

This application claims priority to U.S. Provisional Application No. 60/896,812, filed on Mar. 23, 2007, the disclosure of which is incorporated herein in its entirety by reference.

### TECHNICAL FIELD

The present invention relates to methods and systems for facilitating transactions over interconnected computer systems, such as the Internet. More particularly, the present invention relates to an Internet Exchange and method thereof for facilitating interactions between at least one mobile network operator and at least one Internet content provider.

### BACKGROUND

The next generation mobile Internet is anticipated to provide an end user customizable application environment where traversal between the television, computer and mobile terminal is completely seamless. Mobile Internet applications are truly mashed or matched-up, combined and customized for each end user, and always mobile, i.e. information such as location and presence are dynamically updated and inherently built into the entire end user experience regardless of which wireless operator provides the actual mobile terminal or handset, globally.

There are two main revenue sources for Internet companies: advertisement revenue and subscription fees.

The advertisement revenue model is currently mostly a very straight-forward sponsoring or placement model where the brand (or its representatives) either pays a certain (very small) amount per advertisement served to an end users device (computer, mobile phone, etc), or pays a certain amount each time an end user clicks on a link to a certain web property.

The subscription model is usually a flat monthly fee for access to specific Internet applications or properties, or features of applications, for example MapQuest Mobile with Verizon and Sprint.

The “free” nature of advertisement funded applications is very compelling to end users. Hence, companies built mainly on such revenue have enjoyed incredible growth and valuation in the stock market. Google is an advertisement driven business. AOL is on the other side of the spectrum with Yahoo somewhere in-between. Both AOL and Yahoo are working actively to transfer more of their business to be advertisement-based. Online/Internet advertisement is a rapidly growing part of the overall advertisement business. Advertisement budgets are rapidly moving from “old media” (broadcast TV, printed media, etc) to the Internet. In 2006, advertisement budgets have grown by 16% to $44 billion of a total size of $274 billion. To further grow advertisement revenue, Internet companies need to increase the number of potential end users to which they can serve ads. With around one billion people on the Internet, and more than two billion people having a wireless phone, the wireless space is clearly the next, largely untapped, frontier. Hence, all large Internet companies now have mobility teams ranging anywhere from small groups and departments to full-fledged divisions.

Mobile advertisement already exists in the wireless space, often in limited implementations by the operator directly. Online advertisement cost is measured as Cost Per Mille/Thousand (CPM/T), meaning the cost an advertiser has to pay for a thousand views of, for example, a banner ad on a website (or wireless access protocol (WAP) site).

The potential increase in revenue a more intelligent ad delivery mechanism could reach by including location, presence and preference information is one of the main reasons this space is considered lucrative.

Existing mobile Internet applications are mainly WAP-based and, as such, require only limited cooperation between the wireless network and an

Internet content provider beyond joint marketing and placement on the deck of the mobile device. In certain markets, operators have chosen to limit data traffic of subscribers utilizing properties outside of their own service environment (walled garden) to promote (or force) their subscriber to use the operators' own service layer.

In some cases, Internet companies have cooperated with operators to create an enhanced mobile Internet property that utilizes information from the wireless network (e.g. MapQuest Mobile on Sprint and Verizon networks). In each of these cases, the Internet company must establish relationships with the relevant operators, and, in some cases, establish a presence in the specific market and include a very expensive systems integration project for each vertical implementation of each application.

While it is possible for the very large and more financially healthy Internet companies to fund and execute vertical integration projects with one operator at a time, it is financially ineffective and, from a time-to-market point of view, highly questionable. For smaller niche players, this is an extremely difficult, if not impossible, task. When taking into consideration globalizing a mobile Internet property, the challenge becomes insurmountable for most Internet companies.

From a wireless operator's point of view, similar challenges exist. Having to integrate with multiple Internet companies and continuously support changes and new applications is a very expensive task. A solution for operators is to select a “trusted partner” to act as a middle-man, or broker between the one operator's network and the whole Internet domain. The Applicant has implemented this solution for a client.

The present invention may be an extension of this concept. In the present invention, a party, such as the Applicant, may be more neutral with a broad operator connectivity to offer each Internet company.

### SUMMARY

The present invention, in exemplary embodiments, overcomes the above disadvantages and other disadvantages not described above. Also, the present invention is not required to overcome the disadvantages described above, and an exemplary embodiment of the present invention may not overcome any of the problems described above.

Thus, in one aspect, the present invention is directed an Internet Exchange that is arranged between at least one mobile network operator and at least one Internet content provider. The Internet Exchange may comprise a plurality of mobile network operator domain components, which may include a network presence component containing information related to a presence of a mobile network operated by the at least one mobile network operator; a global location awareness component including information related to a global location of a mobile station in the mobile network; and a device awareness and context component including information related to an awareness and a context of the mobile station in the mobile network.

The Internet Exchange may further comprise a plurality of gateways that may retrieve data from the plurality of mobile network operator domain components and that may facilitate interoperability between the at least one mobile network operator and the at least one Internet content provider. The plurality of gateways may comprise a messaging gateway to deliver messages between the at least one mobile network operator and the at least one Internet content provider; and an advertisement gateway to deliver advertisement consumption information between the at least one mobile network operator and the at least one Internet content provider.

The Internet Exchange may further include a user data management component to manage interactions between the at least one mobile network operator, the plurality of mobile network operator domain components, the mobile station, and the at least one Internet content provider; and a content aggregation and management component to process media information supplied by the at least one Internet content provider to the at least one mobile network operator.

In another aspect, the present invention is directed to a method for facilitating interactions between at least one mobile network operator and at least one Internet content provider via an Internet Exchange. According to this aspect of the present invention, the following information may be gathered: information related to a presence of a mobile network operated by the at least one mobile network operator; information related to a global location of a mobile station in the mobile network; and information related to an awareness and a context of the mobile station in the mobile network. Via a messaging gateway, messages may be delivered between the at least one mobile network operator and the at least one Internet content provider; and, via an advertisement gateway, advertisement consumption information may be delivered between the at least one mobile network operator and the at least one Internet content provider. Furthermore, interactions between the at least one mobile network operator, the mobile station, and the at least one Internet content provider may be managed; and media information, which may be supplied by the at least one Internet content provider to the at least one mobile network operator, may be processed.

In yet another aspect, the present invention is directed to a computer readable medium which comprises instructions for facilitating interactions between at least one mobile network operator and at least one Internet content provider via an Internet Exchange. The instructions may be for gathering the following information: information related to a presence of a mobile network operated by the at least one mobile network operator; information related to a global location of a mobile station in the mobile network; and information related to an awareness and a context of the mobile station in the mobile network. Further, the instructions may be for delivering messages between the at least one mobile network operator and the at least one Internet content provider via a messaging gateway; and for delivering advertisement consumption information between the at least one mobile network operator and the at least one Internet content provider via an advertisement gateway. The instructions may also be for managing interactions between the at least one mobile network operator, the mobile station, and the at least one Internet content provider; and for processing media information that may be supplied by the at least one Internet content provider to the at least one mobile network operator.

The present invention may allow the efficient mobilization of existing Internet properties, but also the creation of new, mashed up, next generation Internet properties and applications. The present invention may effectively globally mobilize and distribute existing Internet properties and content and may provide an ecosystem where new, innovative mobile Internet properties and content distribution mechanisms and profitable business models may be created. The present invention may utilize and expose features and capabilities in wireless networks to Internet content providers. The present invention may provide wireless operators an additional revenue stream from their installed base and may increase mobile Internet usage globally. The present invention may provide operators a mechanism to guard against becoming a pure bit pipe without added value.

### BRIEF DESCRIPTION OF THE DRAWINGS

In the following section, the invention will be described with reference to exemplary embodiments illustrated in the attached Figures, in which:

FIG. 1 illustrates a first system in accordance with an exemplary embodiment of the present invention;

FIG. 2 illustrates a second system in accordance with an exemplary embodiment of the present invention;

FIG. 3 illustrates an application in accordance with an exemplary embodiment of the present invention;

FIG. 4 illustrates a first Internet Exchange in accordance with an exemplary embodiment of the present invention;

FIG. 5 illustrates a second Internet Exchange in accordance with an exemplary embodiment of the present invention;

FIG. 6 illustrates a method flow chart in accordance with an exemplary embodiment of the present invention.

FIG. 7 illustrates a first message flow chart in accordance with an exemplary embodiment of the present invention; and

FIG. 8 illustrates a second message flow chart in accordance with an exemplary embodiment of the present invention.

### DETAILED DESCRIPTION

Reference will now be made in detail to exemplary embodiments of the present invention, examples of which are illustrated in the accompanying drawings.

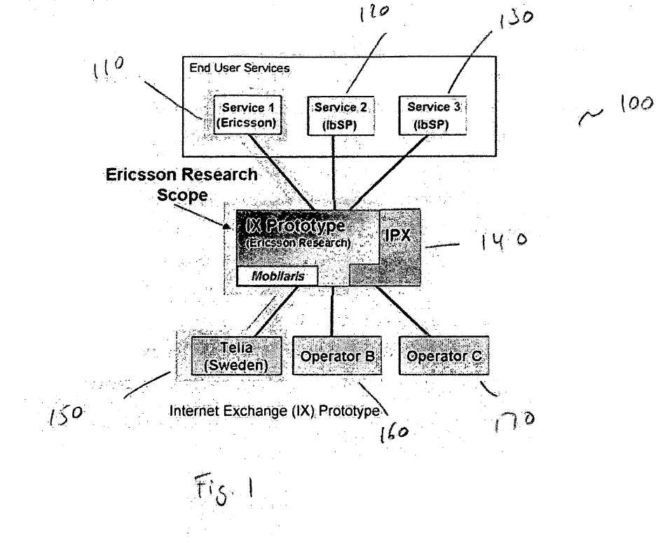

FIG. 1 illustrates a system 100 according to an exemplary embodiment of the present invention. The system 100 may include multiple Internet content providers or Internet-based Service Providers (IbSP) 110, 120, and 130. The system 100 may further include multiple mobile or wireless network operators 150, 160, and 170, such as the Swedish mobile network operator Telia. A broker 140, which is also referred to as an Internet Exchange 140, is arranged between the Internet content providers 110, 120, 130 and the mobile or wireless network operators 150, 160, 170.

It may be one role of the Internet Exchange 140 to gather and mine existing information. This information may be dynamically updated in the respective networks of the mobile or wireless operators 150, 160, 170. The information may then be made available to the Internet content providers 110, 120, 130 via a powerful but cohesive interface. The Internet content providers 110, 120, 120 may integrate and maintain only one application programming interface (API) interface (not shown) towards the Internet Exchange 140. The Internet Exchange 140 may have south-bound connectivity to the respective Service Delivery Platform (SDP) or service layer of the wireless network operators 150, 160, 170, or directly to specific network elements in the respective networks of the operators 150, 160, 170. In some cases, the Internet Exchange 140 may host an element and may derive revenue from such sales. North-bound, the Internet Exchange 140 may expose an API for polling of specific information from the south-bound interfaces. Support for device-specific application development is provided in a “workbench” or framework (not shown).

The wireless operators 150, 160, 170 may be compensated for providing access to the information in their respective networks. The Internet Exchange 140 may provide clear added value to each participant in the entire value chain from the brand, to the advertiser, to the application provider, to the broker, to the operator, and finally to the end-user. By providing a mechanism for more valuable (targeted) advertisement, the brand and advertiser may greatly benefit from a much more efficient use of their advertisement budgets. From an advertisement point of view, the Internet content provider 110, 120, 130 may have access to a solution that provides a much more targeted advertisement reach and hence, the justification for a much higher CPM, i.e. significantly higher revenues.

Other advantages of the present invention may include: a global connectivity solution to reach mobile users; the ability to create next generation mobile Internet applications that inherently incorporate real time information from the wireless network; one integration point for a global solution instead of hundreds; lightweight integration costs (SOAP/XML interface); and no need for formal relationships and presence in all markets.

The Internet Exchange 140 may be an engine that allows for next generation mobile Internet applications to proliferate.

Other values may include: new revenue streams from a completely new industry segment; positioning for the future, in the case where Internet content providers may dominate, partner of choice; up selling opportunities with the traditional customers (more data traffic, more network capacity needed, more access to network sales); and serious credibility among existing operator customers for reverse broker type of engagements.

Among the values to the operator may be the following: new revenue streams from existing network elements; the ability to greatly increase data traffic over their networks; a cost efficient way to offer Internet content provider applications to its subscribers; access to the subscriber base who may be more loyal to Internet content providers than the specific wireless operator (less churn); and clear value in the next generation mobile Internet beyond the pure bit pipe or access provider.

Among the values to the end users may be the following: the new services may be available for mass market devices, not just expensive high-end devices with e.g. built-in GPS; access to a next generation application providing a much better end user experience and a much more enhanced feature set due to utilizing the Internet exchange 140; and ease of use—the Internet Exchange 140 may be completely transparent to the end user.

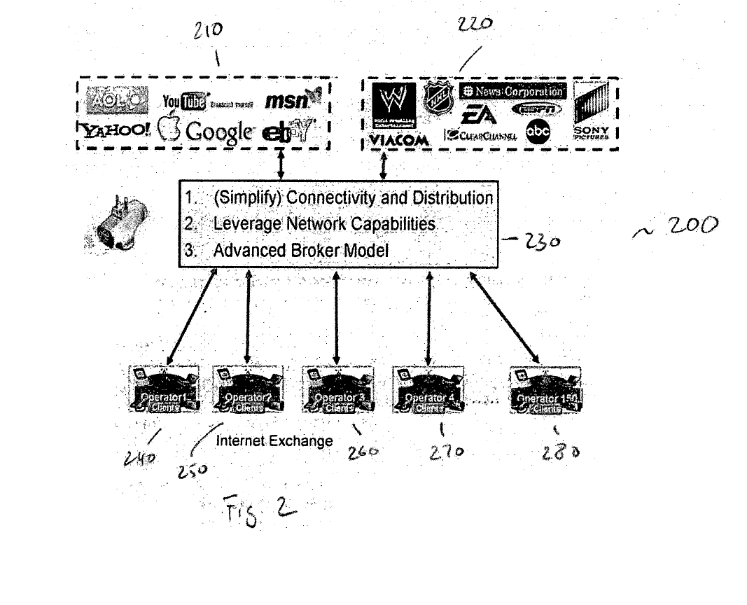

FIG. 2 illustrates a second system 200 in accordance with an exemplary embodiment of the present invention. The system 200 may include multiple Internet content providers 210 and 220, for example companies like AOL, Yahoo, Google, Viacom, News Corporation, etc. The system 200 may further include multiple mobile or wireless network operators 240, 250, 260, 270, and 280. An Internet Exchange 230 is arranged between the Internet content providers 210, 220 and the mobile or wireless network operators 240, 250, 260, 270, 280. As shown in FIG. 2, the Internet Exchange 230 may simplify connectivity and distribution; may leverage network capabilities; and may be based on an Advanced Broker Model.

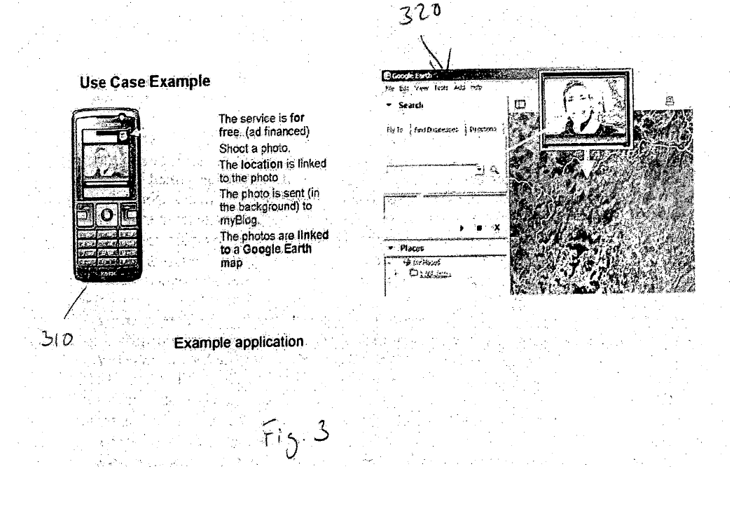

FIG. 3 illustrates an application in accordance with an exemplary embodiment of the present invention. FIG. 3 depicts an automatic, location-aware geo-tagging service example, in which a user of a mobile station 310 may take a picture via a camera (not shown) that may be built into the mobile station 310. Location information of the mobile station 310 may be linked or attached to the photo, and the photo, together with the location information, may be sent to an Internet web page 320. The photo may be linked to an Internet mapping service provider, such as Google Earth, so that both the photo and the location where it was taken are shown on a, for example, Google Earth map on the web page 320.

Other applications in accordance with exemplary embodiments of the present invention may include: an automatic zoom to the current location on mapping properties; automatic follow-me services; location-based mass marketing (everyone at one site); automatic presence updates; preference management; and automatic user identification and validation.

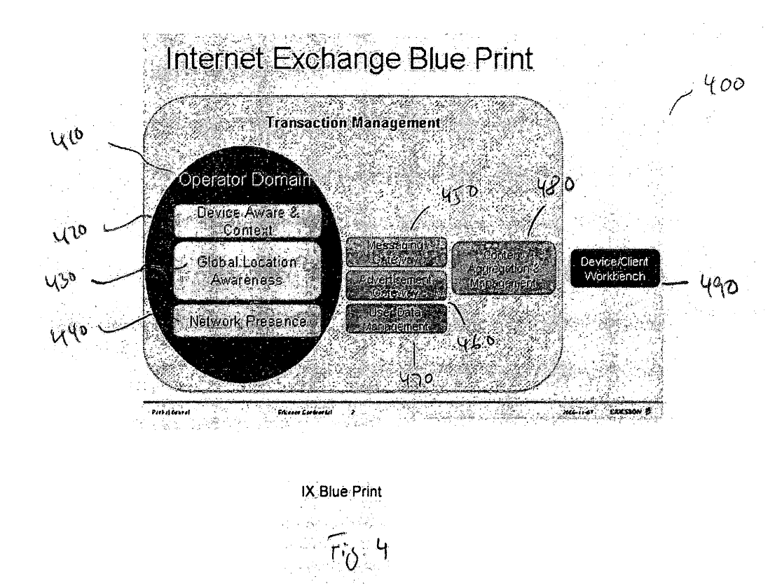

FIG. 4 illustrates a first Internet Exchange 400 in accordance with an exemplary embodiment of the present invention. The illustration in FIG. 4 may also be known as a Blue Print. The Internet Exchange 400 may include an operator domain 410 having a component 420 that includes device-aware and context information of a mobile station in a particular mobile network; a component 430 that includes global location-awareness information of the mobile station; and a component 440 that includes network presence information of the particular mobile network. Note that the location information may be translated and mapped on graphical interfaces, and that these components in the operator domain may include additional network-related information, such as home and roaming information for the mobile station or device. Further, these components are not limited to the set described above, and may vary based on requirements from users, service providers and wireless operators.

The Internet Exchange 400 may also include a video or messaging gateway 450 and an advertisement gateway 460. These gateways 450, 460 may allow for interoperability and delivery—both from a messaging perspective and an advertisement consumption perspective. Both of these gateways 450, 460 may have intelligence based on information retrieved from the operator domain 410.

A user data management component 470 may manage the interaction between various actors in the ecosystem. The component 470 may have the intelligence and expert engine to act based on information received from the operator domain 410, the device or mobile station being used, and the context of the user. Privacy aspects from a user-centric perspective may also be managed.

A content aggregation and management component 480 may largely drive how the Internet Exchange 400 acts with the service providers for managing, storing, formatting and delivering media of various kinds. A device/client workbench 490 may allow user interface developers to rapidly prototype a variety of rich graphical interfaces. These interfaces, in conjunction with the device-aware and context-sensitive component 420, may be downloaded over the air or side loaded on to the device.

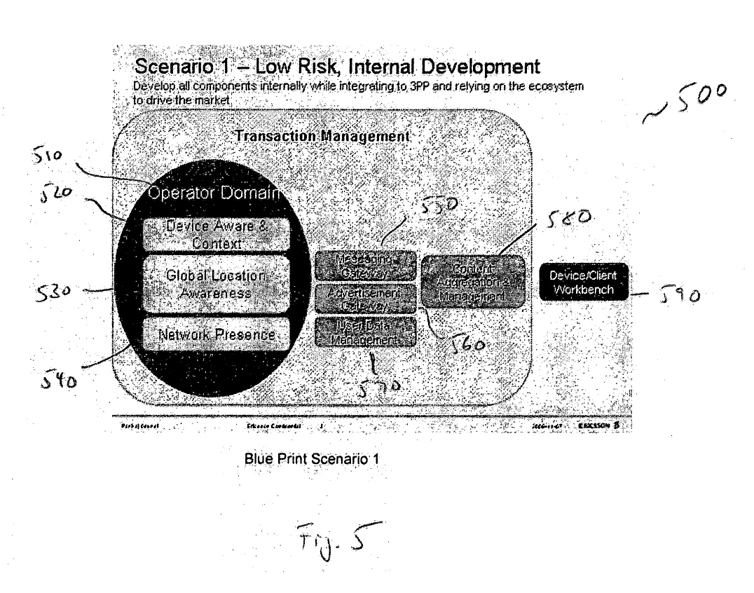

FIG. 5 illustrates a second Internet Exchange 500 in accordance with an exemplary embodiment of the present invention. Similar to the exemplary embodiment shown in FIG. 4, the Internet Exchange 500 may include an operator domain 510 having a component 520 that includes device-aware and context information of a mobile station in a particular mobile network; a component 530 that includes global location-awareness information of the mobile station; and a component 540 that includes network presence information of the particular mobile network. Again, the location information may be translated and mapped on graphical interfaces, and these components in the operator domain may include additional network-related information, such as home and roaming information for the mobile station or device. Further, these components are not limited to the set described above, and may vary based on requirements from users, service providers and wireless operators. The Internet Exchange 500 may also include a video or messaging gateway 550; an advertisement gateway 560; a user data management component 570; a content aggregation and management component 580; and a device/client workbench 590.

The Internet Exchange 500 may provide much-needed operator connectivity for extracting relevant user information based on their context and relationship to the telecom operator. The Internet Exchange 400 shown in FIG. 4 may require systems integration with other third party products for each wireless operator, especially for extracting network information and location. The Internet Exchange 500 shown in FIG. 5 may include connectivity to the operator via a location middleware (not shown). This may facilitate global reach to multiple wireless operators while allowing service providers to deliver context-sensitive data.

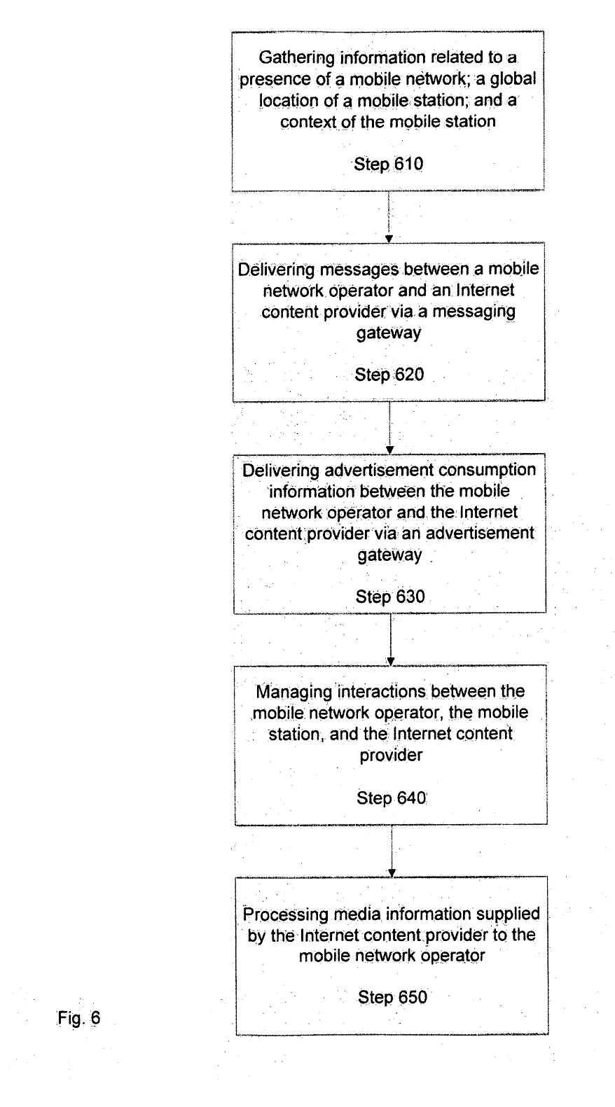

FIG. 6 illustrates a method flow chart in accordance with an exemplary embodiment of the present invention. In step 610, the following information is gathered: information related to a presence of a mobile network operated by at least one mobile network operator; information related to a global location of a mobile station in the mobile network; and information related to an awareness and a context of the mobile station in the mobile network. In step 620, messages may be delivered between the at least one mobile network operator and at least one Internet content provider via a messaging gateway. In step 630, advertisement consumption information may be delivered between the at least one mobile network operator and the at least one Internet content provider via an advertisement gateway. Furthermore, in step 640, interactions between the at least one mobile network operator, the mobile station, and the at least one Internet content provider may be managed; and, in step 650, media information, which may be supplied by the at least one Internet content provider to the at least one mobile network operator, may be processed.

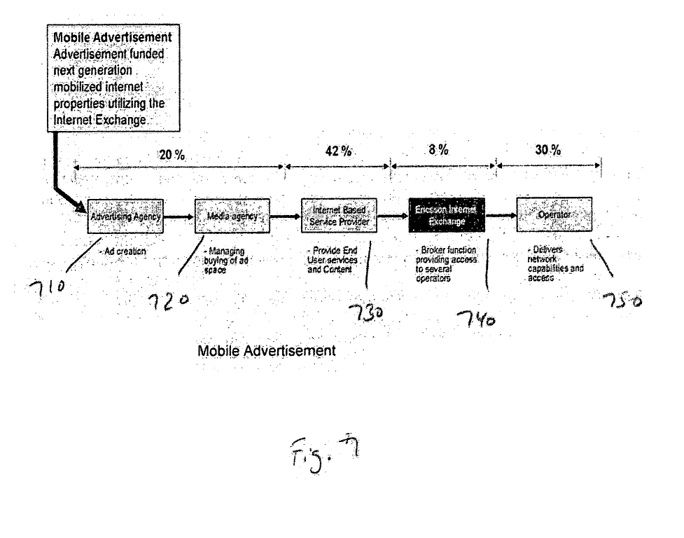

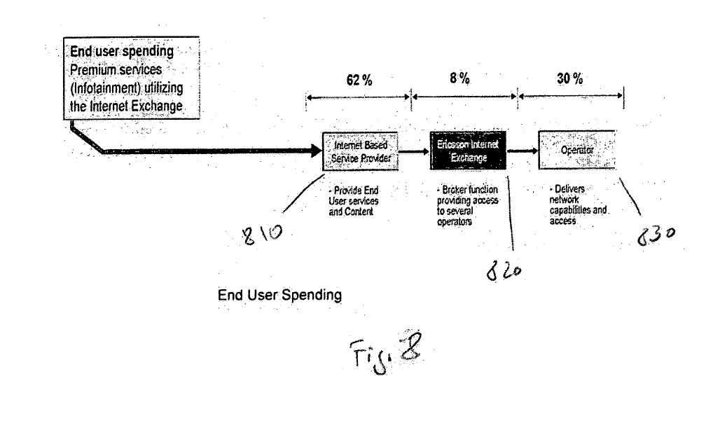

The method in accordance with exemplary embodiments of the present invention may permit revenue to enter the value chain mainly from two sources. For advertisement funded properties, as shown in FIG. 7, the revenue may originate from the advertiser's or the brand's advertisement budgets. For premium services, as shown in FIG. 8, the end user may pay a fee. Depending on the type of property, the end user subscription fee may be transaction based, monthly, weekly, or an annual flat fee.

For advertisement funded properties, as shown in FIG. 7, an advertisement agency 710 may create an ad; a media agency 720 may manage the purchase of ad space; an Internet-based service provider 730 may provide end user services and content; an Internet Exchange 740 may broker access to several wireless network operators; and an operator 750 may deliver network capabilities and access to its network. The total revenue may be shared as follows: 20% to the advertising agency 710 and the media agency 720; 42% to the Internet-based service provider 730; 8% to the provider of the Internet Exchange 740; and 30% to the wireless or mobile network operator 750.

Depending on the offering and size of the ad campaign, additional players may be included within the 20% indicated as advertising agency 710 and media agency 720 in FIG. 7. In some cases, it may be optimal to utilize the wireless operators' billing capabilities and, for example, include premium services charges on the end user's mobile phone bill from the operator 750. In these cases, the revenue share is passed north-bound to the Internet Exchange provider 740 and the Internet content provider or Internet-based service provider 730.

For premium services, as shown in FIG. 8, an Internet-based service provider 810 may provide end user services and content; an Internet Exchange 820 may broker access to several wireless network operators; and an operator 830 may deliver network capabilities and access to its network. The total revenue may be shared as follows: 62% to the Internet-based service provider; 8% to the provider of the Internet Exchange 820; and 30% of to the wireless or mobile network operator 830.

The Internet Exchange model may be flexible enough to manage various business models profitably. Not all Internet content providers may be able to adhere to one payment model, nor may all wireless operators accept the same type of payment for access to their network assets.

There may be four main models that may be facilitated by the present invention: transaction, bulk, flat fee, and revenue share. Note that it may be possible to mix and match each model depending on application and/or property. Also note that the model chosen between the Internet content provider and Internet Exchange may be different from the model between the Internet Exchange and the operator. For example, a broker or Internet Exchange may purchase bulk flat fee access instances (dips) into a certain wireless operator's network element, but then further provide information based on that data to Internet content providers on a transaction basis.

In the transaction model, each time a specific piece of information is requested for an application or Internet property, a charge may occur. In the bulk and flat fee model, access instances may be provided in bulk, possibly for a flat fee for a certain time period or other measurement. In the revenue share model, instead of paying a transaction-dependent fee for each dip into the wireless operator's network, each player (or only certain players) may share in the revenue source. This model may work best in the advertisement funded offerings.

There are three distinct stages of Internet exchange business evolution. They are: Distribution, Intelligent Distribution and Advanced Broker. Within the first stage, the market demand is mainly for global and local content, media and entertainment distribution. Solutions are generally WAP, SMS and MMS based. There will be a need for hosted storefronts, content management and some client integration. Intelligent Distribution refers to the addition of intelligence to the pure content distribution, like e.g. preference and user management (what do I want, when do I want it, how do I want it etc). The advanced broker stage is a next generation mobile Internet property that is purpose-built for a mobile end user experience with highly customizable mashed up features based on fully integrated capabilities and information from the wireless networks.

In the present invention, “added value” from enablers may include information regarding the location of a user, information about terminal status (on/off/roaming), and information about device capabilities. In the present invention, the broker may serve as a conduit minimizing the amount of business agreements and technical integrations needed between Internet content providers and wireless operators. However, there may be some additional values provided by the broker, including: converting potentially complex and diverging protocols from the networks to one simple protocol to integrate with for the IbSP; for location and similar enablement: some aspects of privacy handling, i.e. to check that the user consents with allowing a certain IbSP to position the user; media-related services, as there could be some content adaptation and/or media protocol conversion, depending on if a wireless operator has or does not have such capabilities.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. An Internet Exchange arranged between at least one mobile network operator and at least one Internet content provider, the Internet Exchange comprising:
a plurality of mobile network operator domain components, further comprising:
a network presence component including information related to a presence of a mobile network operated by the at least one mobile network operator;
a global location awareness component including information related to a global location of a mobile station in the mobile network; and
a device awareness and context component including information related to an awareness and a context of the mobile station in the mobile network;
a plurality of gateways operable to retrieve data from the plurality of mobile network operator domain components and facilitate interoperability between the at least one mobile network operator and the at least one Internet content provider, the plurality of gateways further comprising:
a messaging gateway to deliver messages between the at least one mobile network operator and the at least one Internet content provider; and
an advertisement gateway to deliver advertisement consumption information between the at least one mobile network operator and the at least one Internet content provider;
a user data management component to manage interactions between the at least one mobile network operator, the plurality of mobile network operator domain components, the mobile station, and the at least one Internet content provider; and
a content aggregation and management component to process media information supplied by the at least one Internet content provider to the at least one mobile network operator.

2. The Internet Exchange as claimed in claim 1, further comprising a device and client workbench including at least one graphical interface to facilitate data transmissions between the mobile station, the at least one mobile network operator, and the at least one Internet content provider.

3. The Internet Exchange as claimed in claim 1, wherein the data retrieved from the plurality of mobile network operator domain components comprises at least one of the information related to the presence of the mobile network, the information related to the global location of the mobile station, and the information related to the awareness and the context of the mobile station.

4. The Internet Exchange as claimed in claim 1, wherein the data retrieved from the plurality of mobile network operator domain components is dynamically updated.

5. The Internet Exchange as claimed in claim 1, wherein the at least one Internet content provider includes only one application programming interface (API) towards the Internet Exchange.

6. The Internet Exchange as claimed in claim 1, further comprising a network element of the mobile network.

7. The Internet Exchange as claimed in claim 1, wherein the content aggregation and management component is structured to at least one of manage, store, format, and deliver the media information supplied by the at least one Internet content provider.

8. The Internet Exchange as claimed in claim 1, wherein the mobile network comprises a billing database containing compensation information for providing network information to the plurality of mobile network operator domain components.

9. The Internet Exchange as claimed in claim 8, wherein the compensation information is related to at least one of a transaction, bulk, flat fee, and revenue share payment model.

10. A method for facilitating interactions between at least one mobile network operator and at least one Internet content provider via an Internet Exchange, the method comprising the steps of:
gathering information related to a presence of a mobile network operated by the at least one mobile network operator;
gathering information related to a global location of a mobile station in the mobile network;
gathering information related to an awareness and a context of the mobile station in the mobile network;
delivering messages between the at least one mobile network operator and the at least one Internet content provider via a messaging gateway;
delivering advertisement consumption information between the at least one mobile network operator and the at least one Internet content provider via an advertisement gateway;
managing interactions between the at least one mobile network operator, the mobile station, and the at least one Internet content provider; and
processing media information supplied by the at least one Internet content provider to the at least one mobile network operator.

11. The method as claimed in claim 10, further comprising the step of facilitating data transmissions between the mobile station, the at least one mobile network operator, and the at least one Internet content provider via a graphical interface.

12. The method as claimed in claim 10, further comprising the step of retrieving, by at least one of the messaging gateway and the advertisement gateway, at least one of the information related to the presence of the mobile network, the information related to the global location of the mobile station, and the information related to the awareness and the context of the mobile station.

13. The method as claimed in claim 10, further comprising the step of dynamically updating at least one of the information related to the presence of the mobile network, the information related to the global location of the mobile station, and the information related to the awareness and the context of the mobile station.

14. The method as claimed in claim 10, further comprising the step of maintaining only one application programming interface (API) towards the Internet Exchange at the at least one Internet content provider.

15. The method as claimed in claim 10, further comprising the step of hosting a network element of the mobile network in the Internet Exchange.

16. The method as claimed in claim 10, wherein the processing of the media information includes at least one of managing, storing, formatting, and delivering the media information.

17. The method as claimed in claim 10, further comprising the step of compensating at least one mobile network operator for providing network information to the Internet Exchange.

18. The method as claimed in claim 17, wherein the at least one mobile network operator is compensated based on at least one of a transaction, bulk, flat fee, and revenue share payment model.

19. A computer readable medium comprising instructions executed by a computer processor for facilitating interactions between at least one mobile network operator and at least one Internet content provider via an Internet Exchange, the instructions for:
gathering information related to a presence of a mobile network operated by the at least one mobile network operator;
gathering information related to a global location of a mobile station in the mobile network;
gathering information related to an awareness and a context of the mobile station in the mobile network;
delivering messages between the at least one mobile network operator and the at least one Internet content provider via a messaging gateway;
delivering advertisement consumption information between the at least one mobile network operator and the at least one Internet content provider via an advertisement gateway;
managing interactions between the at least one mobile network operator, the mobile station, and the at least one Internet content provider; and
processing media information supplied by the at least one Internet content provider to the at least one mobile network operator.

20. The computer readable medium as claimed in claim 19, further comprising instructions executed by a computer processor for facilitating data transmissions between the mobile station, the at least one mobile network operator, and the at least one Internet content provider via a graphical interface.
